(19) United States
(12) Patent Application Publication
(10) Pub. No.: US 2006/0259772 A1
(43) Pub. Date: Nov. 16, 2006

(54) Authentication of radio frequency transponders

(76) Inventors: Johan Dawid Kruger, Witkoppen, Gauteng (ZA); John McMurray, Midrand, Gauteng (ZA)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/550,458

(22) PCT Filed: Mar. 26, 2004
(86) PCT No.: PCT/IB04/50341

§ 371 Date: Jul. 17, 2006

(30) Foreign Application Priority Data
Mar. 26, 2003 (ZA) 2003/2343

(51) Int. Cl. H04L 9/00

(52) U.S. Cl. 713/176

(57) ABSTRACT

The invention describes a method of authenticating radio frequency (RF) transponders (14.1, 14.2, 14.3, to 14,n) in an electronic identification system (10), the system (10) also comprising an associated reader (18) and a verifier (22). At least one transponder encoder (16.1, 16.2) is provided for writing respective first watermark data into a memory arrangement of each transponder (14.1, 14.2, 14.3, to 14.n). A verifier (22) interrogates a selected transponder (14.1) to read data stored in the transponder (14.1), the verifier (22) using the read data to derive from its memory an algorithm and input data from which to derive second watermark data for comparison with the first watermark data and provide a signal indicative of the authentication of the transponder. Alternatively the comparison between the first and second watermark data can take place in the transponder (14.1) which is arranged to provide a signal to the verifier (22) as to the authenticity of the transponder (14.1).

### TECHNICAL FIELD

The invention relates to electronic identification systems and methods of authentication and more particularly, but not exclusively, to such systems and methods using radio frequency (RF) transponders and associated readers, interrogators and verifiers therefor.

### BACKGROUND ART

A system of the aforementioned kind is typically used to mark and identify products or goods, and would further include a plurality of encoder units for writing data into respective memory arrangements of the transponders. In use, a transponder is attached to a product item and the data written into the transponder may relate to the kind of product, the date of manufacture and/or any other data relating to the product. Normally the data is written into the memory arrangement at the source of the product, but in some applications additional data may be written into the memory arrangement at various points along a distribution chain. Of course the data written into the memory arrangement can at any stage be read with a verifier, interrogator or reader.

In some applications, security arrangements are required which would prevent unauthorized parties from attaching non-genuine transponders (purporting to store data encoded by an authorised encoder) to grey or infringing goods, thereby facilitating passing the grey goods off as genuine goods.

### OBJECT OF THE INVENTION

Accordingly, it is an object of the present invention to provide a system and method with which the applicant believes transponders originating from an authorized source could be distinguished from non-genuine transponders.

### SUMMARY OF THE INVENTION

According to the invention there is provided an electronic identification system comprising:
a plurality of transponders;
at least one transponder encoder for writing respective first watermark data into a memory arrangement of each transponder;
at least one verifier for interrogating a selected transponder and to read data stored in the transponder;
said first watermark being derived from an algorithm and input data;
the verifier comprising computing means configured to retrieve the algorithm and the input data and to compute second watermark data for comparison with the first watermark data.

The algorithm may be an encryption algorithm and the input data may comprise at least one of a constant and a variable.

The system may further comprise at least one conventional reader for reading the data transmitted, but which does not comprise the computing means configured as aforesaid.

Hence, the at least one verifier is used for verification of the authenticity of a transponder and the at least one conventional reader merely for reading data transmitted by the transponder when interrogated.

The data transmitted by the transponder may comprise the first watermark data and identification code data associated with the transponder.

The at least one verifier may utilize said identification code data to retrieve the algorithm and the input data from memory means of the verifier.

At least part of the input data may alternatively or in addition be derived from sensor means response to a parameter of the response signal or a communications channel with the transponder.

According to another aspect of the invention there is provided a method of authenticating a transponder of an electronic identification system, the method comprising the steps of:
writing into a memory arrangement of the transponder first watermark data derived from an algorithm and input data for the algorithm;
interrogating the transponder by causing the transponder to transmit to a verifier a response signal comprising data stored in the memory arrangement of the transponder;
utilizing at the verifier the transmitted data to retrieve the algorithm and the input data;
utilizing the retrieved algorithm and input data to compute second watermark data; and
comparing the first watermark data and the second watermark data to give an indication of the authenticity of the transponder.

The first watermark data may be generated by an encoder and may then be written into the memory arrangement of the transponder.

The encoder may be connectable to a central station for downloading into a memory arrangement of the encoder a set of algorithms comprising said algorithm.

The central station and/or encoder may further be configured to write the set of algorithms and input data for the set of algorithms into a memory arrangement of the verifier. Said algorithm and said input data for said algorithm may be stored in the verifier in relation to identification code data of the transponder.

The input data may be arbitrarily selected data and may be changed by the encoder from time to time.

The data transmitted to the verifier in the response signal may comprise said identification code data of the transponder. The identification code data may be utilized by the verifier to retrieve said algorithm and said input data.

The input data for said algorithm may further comprise data derived by the verifier from a parameter of said response signal or a communications channel with the transponder.

In some forms of the method the step of comparing the first watermark data and the second watermark data may be performed on the verifier. In these cases, the first watermark data is transmitted by the transponder to the verifier.

In other forms of the method the step of comparing the first watermark data and the second watermark data may be performed on the transponder. In these cases, the second watermark data would be computed on the verifier and then transmitted to the transponder where the comparison is performed. The transponder may then provide the indication of the authenticity of the transponder.

In another aspect of the invention there is provided a verifier for authenticating a transponder, comprising a transmitter for transmitting an interrogation signal to the transponder, a receiver for receiving a response signal from the transponder, the response signal carrying or embodying ID code data of the transponder, a controller for utilizing the ID code data to retrieve from a memory arrangement an algorithm and input data associated with the transponder, and processing means for deriving computed watermark data from the retrieved algorithm and associated input data.

In one embodiment the verifier is arranged to transmit the computed watermark data to the transponder for comparison with stored watermark data stored within the memory of the transponder. Alternatively, the verifier is arranged to compare the computed watermark data with stored watermark data in the memory arrangement of the verifier. The retrieved algorithm may be an encryption algorithm and the retrieved input data is at least one of a constant and a variable.

In another aspect of the invention there is provided a transponder for use in an electronic identification system, comprising a transmitter for sending a response signal to a verifier, the response signal carrying or embodying ID code data of the transponder, a receiver for receiving from the verifier computed watermark data derived from a retrieved algorithm and associated input data in the memory arrangement of the verifier, and processing means for comparing the computed watermark data with stored watermark data stored within the memory of the transponder, to establish authentication of the transponder.

The transponder may be arranged to transmit an authenticity signal to the verifier indicative of the authenticity or otherwise of the transponder.

### BRIEF DESCRIPTION OF THE ACCOMPANYING DIAGRAMS

The invention will now further be described, by way of example only, with reference to the accompanying diagrams wherein

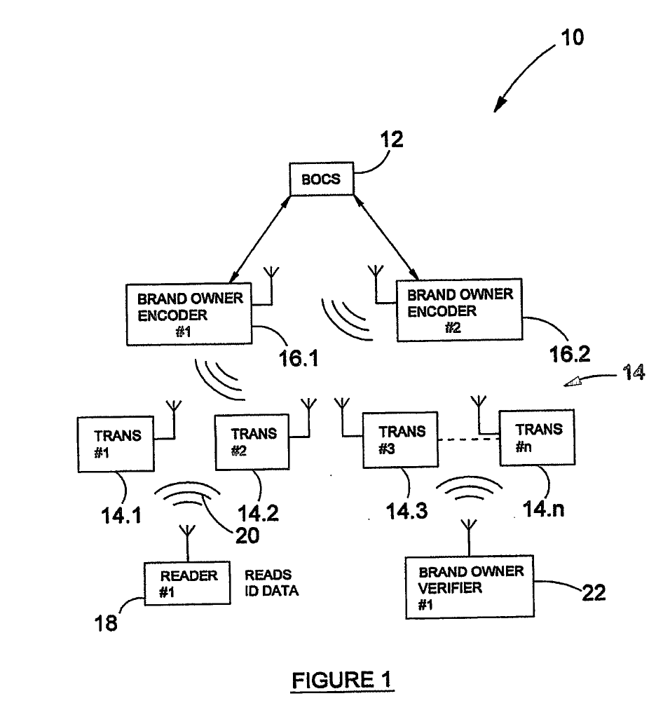

FIG. 1 is a block diagram of an electronic identification system according to the invention;

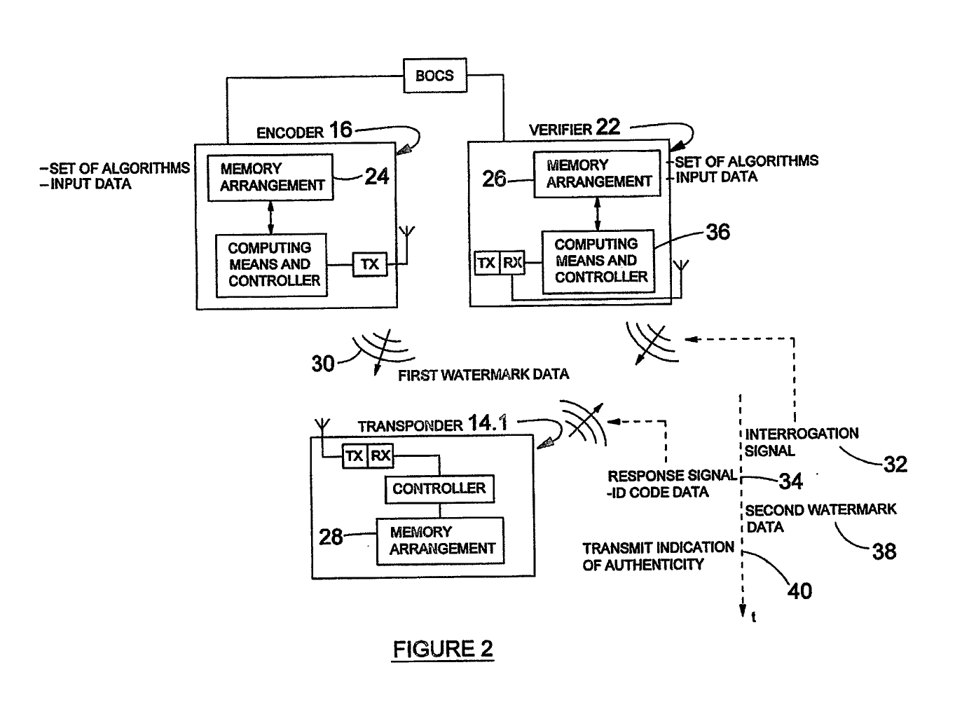

FIG. 2 is a more detailed block diagram of an encoder, a transponder and a verifier of the system; and

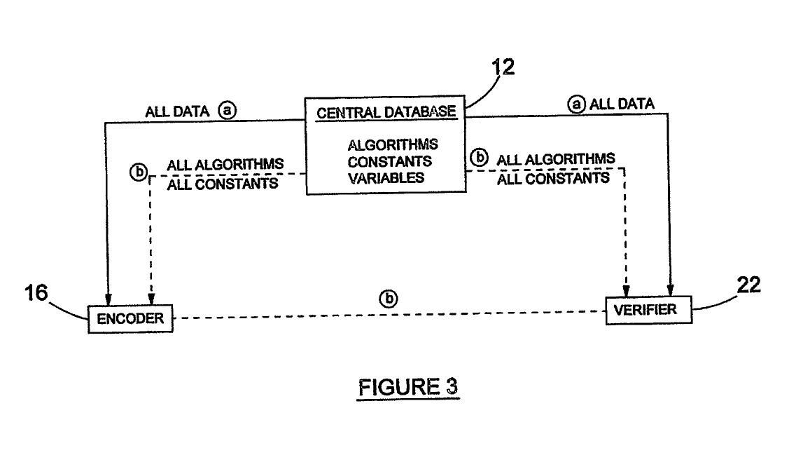

FIG. 3 is a diagram illustrating different aspects of the method according to the invention.

### DESCRIPTION OF PREFERRED EMBODIMENTS OF THE INVENTION

In FIG. 1 there is shown a block diagram of an electronic radio frequency identification (RFID) system according to the invention designated 10.

The system comprises a brand owner central computer system (BOCS) 12 of a brand owner of articles to be tagged and/or marked with transponders 14.1, 14.2, 14.3, to 14.n of the system. The system further comprises a plurality of encoder devices 16.1. to 16.n which are proprietary to and controlled by the brand owner. The system still further comprises a plurality of conventional readers or interrogators 18 for reading the transponders in well-known manner. The reader is caused to broadcast an RF interrogation signal 20 towards a transponder population 14. The transponders are energized in well-known manner by the signal and each causes a response signal comprising respective identification code data stored in a memory arrangement of the transponder to be transmitted to the reader. The reader receives the response signal, extracts the data and identify and/or count the transponder utilizing said data.

The system further comprises a plurality of verifiers 22 which are proprietary to and/or controlled by the aforementioned brand owner.

In the system according to the invention, first watermark data is in addition to the aforementioned ID data electronically written to and stored in the memory arrangement of the transponder. The first watermark data is so written into the transponder by an encoder 16.1 as will hereinafter be described with reference to FIG. 2.

The first watermark is derived from an algorithm and input data for the algorithm. A set of algorithms and associated input data is written by BOCS 12 into a memory arrangement 24 of the encoder 16. The encoder computes the first watermark data by selecting one algorithm of said set of algorithms and associated input data. Data relating to the selected algorithm and input data are also written into a memory arrangement 26 of verifier 22. The first watermark data is downloaded into and stored in a memory arrangement 28 of the transponder as shown at 30 in FIG. 2.

To verify the authenticity of the transponder 14.1, the verifier 22 is used as hereinafter described. Normal and conventional reading of the ID code data of the transponder is performed with conventional reader 18 shown in FIG. 1.

The verifier 22 is caused to transmit an interrogation signal 32 to the transponder. The transponder derives power from this signal and transmits a response signal 34 carrying or embodying the ID code data. The controller 36 of the verifier utilizes the ID code data to retrieve from memory arrangement 26 the algorithm and input data associated with transponder 14.1. The computing means of the verifier then utilizes the retrieved algorithm and associated input data to compute second watermark data. The verifier thereupon transmits at 38 the computed second watermark data to the transponder 14.1.

The controller 40 of the transponder 14.1 is configured to compare the stored first watermark data and the received second watermark data. If the compared data correspond, the transponder 14.1 provides a first indication to the verifier 22 at 40 and if the data do not correspond, a second indication is provided.

In other forms of the method, the transponder 14.1 is caused to transmit with the response signal 34, the first watermark data to the verifier 22. The comparison between the first watermark data and the second watermark data computed by the verifier is then performed by computing means 36 on the verifier 22. The verifier would then also generate one of the aforementioned first and second indications, depending on an outcome of the comparison.

The aforementioned input data for the algorithm may comprise at least one of a constant and a variable. The constant may be an arbitrarily selected number and need not have any direct relation with the ID code data. The set of algorithms, constants and variables may all be downloaded into the encoder and the verifier as hereinbefore described. This is illustrated by the lines designated a in FIG. 3. In other forms of the method, the variable may be a parameter of a signal 32, 34 or a communications channel between the transponder 14.1 and the verifier 22 and may in effect be carried by the transponder to be available to both the encoder and the verifier. This aspect is illustrated be the lines designated b in FIG. 3. In still further forms, at least part of the input data for the algorithm may be transferred from the central computer or encoder to the verifier and that data may be retrieved by the verifier, before computing the second watermark data.

It will be appreciated that there are many variations in detail on the system, the encoder, verifier, transponder and method according to the invention without departing from the scope and spirit of this disclosure.

1-24. (canceled)

25. An electronic identification system comprising:
a plurality of transponders;
at least one transponder encoder for writing respective first watermark data into a memory arrangement of each transponder;
at least one verifier for interrogating a selected transponder and to read data stored in the transponder;
said first watermark being derived from an algorithm and input data;
the verifier comprising computing means configured to retrieve the algorithm and the input data and to compute second watermark data for comparison with the first watermark data.

26. An electronic identification system as claimed in claim 25, wherein the algorithm is an encryption algorithm and the input data is at least one of a constant and a variable.

27. An electronic identification system as claimed in claim 25, including at least one reader for reading the data transmitted, the reader not comprising the computing means configured as aforesaid.

28. An electronic identification system as claimed in claim 27, wherein said at least one verifier is used for verification of the authenticity of a transponder and said at least one reader is merely for reading data transmitted by the transponder when interrogated.

29. An electronic identification system as claimed in claim 25, wherein the data transmitted by the transponder comprises the first watermark data and identification code data associated with the transponder.

30. An electronic identification system as claimed in claim 29, wherein said at least one verifier utilizes said identification code data to retrieve the algorithm and the input data from memory means of the verifier.

31. An electronic identification system as claimed in claim 30, wherein at least part of the input data is alternatively or in addition derived from sensor means response to a parameter of the response signal or a communications channel with the transponder.

32. A method of authenticating a transponder of an electronic identification system, the method comprising the steps of:
writing into a memory arrangement of the transponder first watermark data derived from an algorithm and input data for the algorithm;
interrogating the transponder by causing the transponder to transmit to a verifier a response signal comprising data stored in the memory arrangement of the transponder;
utilizing at the verifier the transmitted data to retrieve the algorithm and the input data;
utilizing the retrieved algorithm and input data to compute second watermark data; and
comparing the first watermark data and the second watermark data to give an indication of the authenticity of the transponder.

33. A method as claimed in claim 32, wherein the first watermark data is generated by an encoder and is written into the memory arrangement of the transponder.

34. A method as claimed in claim 32, wherein the encoder is connectable to a central station for downloading into a memory arrangement of the encoder a set of algorithms comprising said algorithm.

35. A method as claimed in claim 34, wherein the central station and/or encoder are further configured to write the set of algorithms and input data for the set of algorithms into a memory arrangement of the verifier.

36. A method as claimed in claim 32, wherein said algorithm and said input data for said algorithm are stored in the verifier in relation to identification code data of the transponder.

37. A method as claimed in claim 32, wherein the input data is arbitrarily selected data and is changed by the encoder from time to time.

38. A method as claimed in claim 32, wherein the data transmitted to the verifier in the response signal comprises identification code data of the transponder.

39. A method as claimed in claim 38, wherein the identification code data is utilized by the verifier to retrieve said algorithm and said input data.

40. A method as claimed in claim 32, wherein the input data for said algorithm further comprises data derived by the verifier from a parameter of said response signal or a communications channel with the transponder.

41. A method as claimed in claim 32, wherein the step of comparing the first watermark data and the second watermark data is performed on the verifier, the first watermark data being transmitted by the transponder to the verifier.

42. A method as in claim 32, wherein the step of comparing the first watermark data and the second watermark data is performed on the transponder, the second watermark data being computed on the verifier and then transmitted to the transponder where the comparison is performed, the transponder then providing the indication of the authenticity of the transponder.

43. A verifier for authenticating a transponder, comprising a transmitter for transmitting an interrogation signal to the transponder, a receiver for receiving a response signal from the transponder, the response signal carrying or embodying ID code data of the transponder, a controller for utilizing the ID code data to retrieve from a memory arrangement an algorithm and input data associated with the transponder, and processing means for deriving computed watermark data from the retrieved algorithm and associated input data.

44. A verifier as claimed in claim 43, wherein the verifier is arranged to transmit the computed watermark data to the transponder for comparison with stored watermark data stored within the memory of the transponder.

45. A verifier as claimed in claim 43, wherein the verifier is arranged to compare the computed watermark data with stored watermark data in the memory arrangement of the verifier.

46. A verifier as claimed in claim 43, wherein the retrieved algorithm is an encryption algorithm and the retrieved input data is at least one of a constant and a variable.

47. A transponder for use in an electronic identification system, comprising a transmitter for sending a response signal to a verifier, the response signal carrying or embodying ID code data of the transponder, a receiver for receiving from the verifier computed watermark data derived from a retrieved algorithm and associated input data in the memory arrangement of the verifier, and processing means for comparing the computed watermark data with stored watermark data stored within the memory of the transponder, to establish authentication of the transponder.

48. A transponder as claimed in claim 47, arranged to transmit an authenticity signal to the verifier indicative of the authenticity or otherwise of the transponder.
